(19) United States
(12) Patent Application Publication
(10) Pub. No.: US 2015/0145820 A1
(43) Pub. Date: May 28, 2015

(54) GRAPHICS EDITING METHOD AND ELECTRONIC DEVICE USING THE SAME

(71) Applicant: ELAN MICROELECTRONICS CORPORATION, Hsinchu (TW)

(72) Inventors: JUNG-SHOU HUANG, HSINCHU COUNTY (TW); CHIA-MU WU, TAIPEI CITY (TW); BO-YU KE, TAICHUNG CITY (TW)

(21) Appl. No.: 14/536,558

(22) Filed: Nov. 7, 2014

(30) Foreign Application Priority Data
Nov. 22, 2013 (TW) 102142646

(51) Int. Cl. G06F 3/041; G06F 3/0354; G06F 3/044

(52) U.S. Cl. CPC G06F 3/0416; G06F 3/0412; G06F 3/044; G06F 3/03545; G06F 2203/04106
USPC 345/174; 345/173

(57) ABSTRACT

The present disclosure provides a graphics editing method, which is adapted to an electronic device having a touch panel and operating in a graphic editing mode. The method includes the following steps. While the electronic device is operating in the graphic editing mode, a first function is executed such that the electronic device displays a graphical trace according to an operation performed on the touch panel by a first touch object. Thereafter, when at least one touch event occurs on the electronic device is detected, the touch panel senses and computes a sensing area associated with the touch event. The electronic device then compares the sensing area and a predefined area threshold. When the electronic device determines that the sensed area is larger than the predefined area threshold, the electronic device executes a second function under the graphic editing mode.

### BACKGROUND

1. Technical Field

The present disclosure relates to a graphics editing method of an electronic device, and in particular, to a graphics editing method for an electronic device having haptic capability and an electronic device using the same.

2. Description of Related Art

With the advancement of touch-screen technology, touch inputs in general are made by touching a touch-screen with a stylus provided or a finger of a user in a way such that the corresponding graphic information is displayed on the touch-screen or a preset function is executed. Accordingly, styluses provide users with a convenient way to operate electronic devices, particularly in the writing or drawing applications, and currently have been widely used for electronic devices equipped with touch-screen displays, such as smartphones, laptops, tablets, and PDAs. Styluses are commonly used with resistive touch panels, capacitive touch panels, or electromagnetic touch panels.

The operation principle of a stylus used with a capacitive touch panel is basically to detect the touch position of the capacitive stylus relative to the capacitive touch panel based on the instantaneous change in capacitive coupling generated as the stylus contacts or touches the capacitive touch panel. Styluses for capacitive touch panels generally are classified into active and passive styluses. An active stylus has a built-in power circuit and a transmitter circuit built-in thereof. When the active stylus touches or comes within proximity of a capacitive touch panel, the active stylus operatively transmits driver signals with the built-in transmitter circuit and causes a change in capacitance to occur on the capacitive touch panel at the location of the touch or in proximity, and the capacitive touch panel computes the touch position accordingly thereafter. Additionally, the active stylus with buttons installed thereon may further provide different driving signals by means of pressing buttons such that the capacitive touch panel can be driven to operatively execute a variety of functions, such as display a selection menu or clear a screen according to the driving signals received. However, the structure of an active stylus is in general complex, and therefore the manufacturing cost is relatively high.

On the contrary, in the case of a passive stylus, the capacitive touch panel can only detect the touch position associated with the passive stylus by detecting a change in capacitance that occurs on the capacitive touch panel at the touch or contact location as the passive stylus have neither a power nor a transmitting circuit built-in thereof. Although passive styluses have the advantages of simple structure and relatively low manufacture cost, nevertheless passive styluses are unable to conduct a variety of functions by operating buttons in the way active styluses do. Thus, it can be noted from above that each type of stylus is subject to its own operating and/or structure limitations when comes to conducting a variety of functions on the capacitive touch panel, thereby causing operation inconvenience.

### SUMMARY

Accordingly, exemplary embodiments of the present disclosure provide a graphic editing method and an electronic device using the same, which can drive the electronic device to perform a variety of functions based on the size of the contact area between a touch object (e.g., a finger or a stylus) and the electronic device.

An exemplary embodiment of the present disclosure provides a graphic editing method, which is adapted to an electronic device having a touch panel and operating in a graphic editing mode. The graphic editing method includes the following steps. While the electronic device is operating in the graphic editing mode, a first function is executed such that the electronic device displays a graphical trace according to an operation performed on the touch panel by a first touch object (e.g., a stylus or a finger). Thereafter, at least a touch event that occurs on the electronic device is detected and a sensed area associated with the touch event sensed by the touch panel is computed. The sensed area is subsequently compared with a predefined area threshold. When the sensed area is computed to be larger than the predefined area threshold, executing the second function under the graphic editing mode.

According to one exemplary embodiment of the present disclosure, wherein the first function is a writing function under the graphic editing mode and the second function is a clear function, a select function, or a zoom-in function.

According to one exemplary embodiment of the present disclosure, wherein when the electronic device determines that the sensed area generated responsive to capacitive coupling between the first touch object or a second touch object is larger than the predefined area threshold, the electronic device operatively detects a touch trace associated with the first touch object or the second touch object and clears a screen shown on a display of the electronic device upon determining that the touch trace associated with the first touch object or the second touch object matches a predefined trace or a predefined gesture.

Another exemplary embodiment of the present disclosure provides a graphic editing method, which is adapted to an electronic device having a touch panel and operating in a graphic editing mode. The graphic editing method includes the following steps. Whether a sensed area generated responsive to capacitive coupling between a touch object and the touch panel is larger than a predefined area threshold is first detected. When determined that the sensed area is smaller than the predefined area threshold, the electronic device is driven to execute a first function under the graphic editing mode according to an operation performed on the touch panel by the touch object. When determined that the sensed area is larger than the predefined area threshold, the electronic device is driven to execute a second function under the graphic editing mode according to the operation performed on the touch panel by the touch object.

An exemplary embodiment of the present disclosure provides an electronic device, and the electronic device includes a display, a touch panel disposed on one side of the display, and a control unit. The control unit is coupled to the display and the touch panel. The touch panel is configured to sense and generate a sensing information associated with a first touch object on the touch panel, wherein the sensing information at least comprises a sensed area between the first touch object and the touch panel. The control unit operatively determines whether the sensed area is larger than a predefined area threshold. When the control unit determines that the sensed area is smaller than the predefined area threshold, the control unit operatively executes a first function according to an operation performed on the touch panel by the first touch object. When the control unit determines that the sensed area is larger than the predefined area threshold, the control unit operatively executes a second function according to the operation performed on the touch panel by the first touch object.

According to one exemplary embodiment of the present disclosure, wherein the first function is a writing function under the graphic editing mode and the second function is a clear function, a select function, or a zoom-in function.

According to one exemplary embodiment of the present disclosure, wherein the first touch object is a stylus and the second touch object is a stylus or a finger.

An exemplary embodiment of the present disclosure provides a non-transitory computer-readable media, for storing a computer executable program for the aforementioned graphic editing method. When the non-transitory computer readable recording medium is read by a processor, the processor executes the aforementioned graphic editing method.

To sum up, exemplary embodiments of the present disclosure provide a graphic editing method and an electronic device having a touch panel using the same, which can operatively determine an editing function (e.g., writing, selecting zoom-in/out or screen clear) to be executed by the electronic device according to the size of contact area between a touch object (e.g., a finger or a stylus) operated by a user and the touch panel of the electronic device and the operation performed on the touch panel by the touch object, and causes the electronic device to execute a variety of functions, and thereby enhances the operation convenience of the electronic device.

In order to further understand the techniques, means and effects of the present disclosure, the following detailed descriptions and appended drawings are hereby referred, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram illustrating an electronic device provided in accordance to an exemplary embodiment of the present disclosure.

FIG. 2 is a diagram illustrating an operation of a touch panel provided in accordance to an exemplary embodiment of the present disclosure.

FIG. 3A-FIG. 3D are diagrams respectively illustrating operations of an electronic device provided in accordance to an exemplary embodiment of the present disclosure.

FIG. 4A is a diagram illustrating a touch operation of an electronic device provided in accordance to an exemplary embodiment of the present disclosure.

FIG. 4B is a diagram illustrating an operation of a touch panel provided in accordance to an exemplary embodiment of the present disclosure.

FIG. 5 is a flowchart diagram illustrating a graphic editing method provided in accordance to an exemplary embodiment of the present disclosure.

FIG. 6 is a flowchart diagram illustrating a graphic editing method provided in accordance to another exemplary embodiment of the present disclosure.

FIG. 7 is a flowchart diagram illustrating a graphic editing method provided in accordance to another exemplary embodiment of the present disclosure.

FIG. 8 is a flowchart diagram illustrating a graphic editing method provided in accordance to another exemplary embodiment of the present disclosure.

FIG. 9 is a flowchart diagram illustrating a graphic editing method provided in accordance to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

The present disclosure provides a graphic editing method, which is adapted to an electronic device having a touch panel. While the electronic device operates under a graphic editing mode, the graphic editing method is capable of operatively determining a graphic editing function under the graphic editing mode to be executed by the electronic device according to the size of the contact area sensed between a touch object (e.g., a stylus or a finger) and a display of the electronic device for a touch event, so as to enable the electronic device to achieve the objective of performing a variety of functions in a single touch operation. It is worth to note that the graphic editing mode herein represents an operation mode, in which the electronic device operates to enable the user to add or edit graphics, characters, symbols, or the combination thereof shown on the display of the electronic device.

(An Exemplary Embodiment of an Electronic Device Using a Graphic Editing Method)

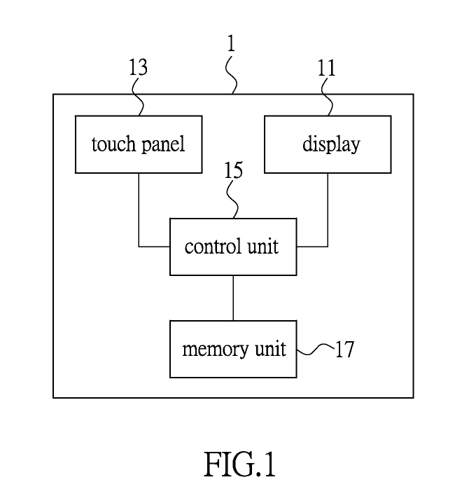

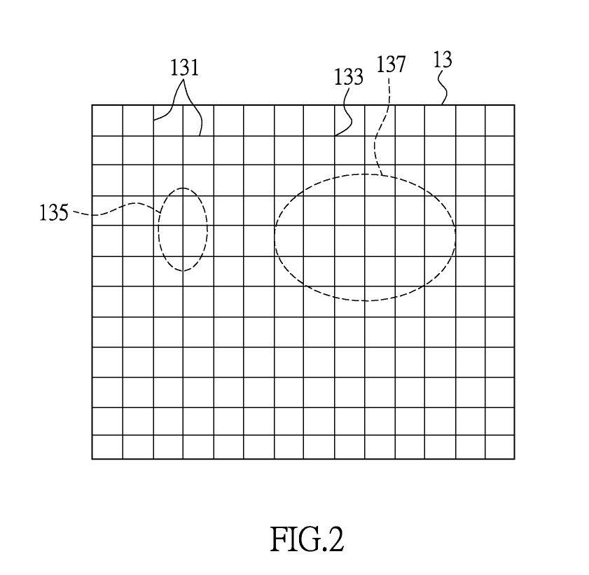

Please refer to FIG. 1 and FIG. 2. FIG. 1 shows a block diagram illustrating an electronic device provided in accordance to an exemplary embodiment of the present disclosure. FIG. 2 shows a diagram illustrating an operation of a touch panel provided in accordance to the exemplary embodiment of the present disclosure.

In the instant embodiment, an electronic device 1 is an electronic device having a touch panel and can include, but not limited to a smartphone, a laptop, a tablet, a personal digital assistant (PDA), and a digital camera. The electronic device 1 is operable to operate in a graphic editing mode and to actively determine the operation of the electronic device 1 under the graphic editing mode based on the size of the contact area between at least one touch object and a display of the electronic device 1 sensed by the touch panel.

More specifically, the electronic device 1 includes a display 11, a touch panel 13, a processing unit 15, and a memory unit 17. The touch panel 13 is disposed on one side of the display 11, wherein the touch panel 13 may be attached to the display 11 via adhesive, although the present disclosure is not limited thereto. The display 11, the touch panel 13, and the memory unit 17 are coupled to the control unit 15, respectively. The control unit 15 operatively controls the operations of the display 11, the touch panel 13, and the memory unit 17 according to the operation of the electronic device 1.

The display 11 is configured to display a screen thereon in coordination to the operation of the electronic device 1 for a user of the electronic device 1 to view and operate electronic device 1, accordingly.

The touch panel 13 is configured to operatively detect one or more touch events occurred on the electronic device 1. The touch panel 13 operatively senses and generates a sensing information associated with the operation of a touch object on the touch panel 13 upon detecting that a touch event has occurred on the electronic device 1. The sensing information at least comprises a sensed area generated responsive to capacitive coupling between the touch object or another touch object and the touch panel 13. The touch object described herein may be a stylus or a finger.

It is worth to mention that the exact structure and the operation associated with the stylus are well known in the art and are not the focuses of the present disclosure, thus further descriptions are hereby omitted.

To put it concretely, the touch panel 13 may be implemented by a single-layer or two-layer capacitive touch panel, although the present disclosure is not limited thereto. In the instant embodiment, the touch panel 13 comprises of a substrate (not shown) and a plurality of sensing lines 131 formed on the substrate. The sensing lines 131 are arranged interlacedly on the substrate. The interlacedly arranged sensing lines 131 are capacitively coupled forming a plurality of sensing points 133, in particular, any two intersected sensing lines 131 are capacitively coupled to form a sensing point 133 at the intersection.

When the touch panel 13 is touched by a touch object, the capacitance of at least one sensing point 133 on the touch panel 13 corresponding to the touch position of the touch object will undergoes a change. Thus, the touch panel 13 may detect whether a touch event has occurred on the electronic device 1 by sensing or detecting the change of the capacitance between the sensing points 133 on the touch panel 13 and the touch object (e.g., the stylus) or another touch object (i.e., by sensing the sensing value or the dV value associated with the sensing points 133). The touch panel 13 correspondingly generates and outputs the sensing information to the control unit 15 upon detecting an occurrence of a touch event on the electronic device 1 for the control unit 15 to process and analyze the sensing area (e.g., a sensing area 135 or a sensing area 137) and the touch position associated with the touch object or the another touch object.

It is worth to note that those skilled in the art may configure the control unit 15 to utilize the mutual-scan technique, the self-scan technique or the combination thereof to scan the sensing lines 131 on the touch panel 13. When the touch panel 13 detects that the touch object is touching the touch panel 13 (e.g., when the user touches the touch panel 13 with a finger of the user or a stylus) regardless the type of scan method employed by the control unit 15 in driving and scanning the touch panel 13, the touch panel 13 will operatively sense the change of the capacitance associated with the sensing points 133 through the respective sensing lines 133 and determine the touch position and the sensed area associated with the touch object, accordingly. Scanning the touch panel 13 using either the mutual-scan technique or the self-scan technique are not the main focus of the present disclosure and are known in the art, therefore further descriptions are hereby omitted.

In the instant disclosure, the sense area (e.g., the sensed area 135 or 137) is the number of the plurality of sensing points 133 on the touch panel 13 having the change in capacitance (i.e., the sensing value or the dV value of the sensing points 133) responsive to the touch object being greater than a sensing threshold. The sensing threshold herein is a predefined capacitance sensing value. The sensing threshold is used for determining whether the touch object touches the touch panel 131 and preventing the touch panel 13 from making false detections under the influence of the change in capacitance due to ambient noises and/or water drop. When detects that a touch event has occurred on the electronic device 1 and the sensing points 133 have a change in capacitance being greater than the sensing threshold, the touch panel 13 determines that the touch event is triggered by the touch object and computes the number of sensing points 133 on the touch panel 13 having the change in capacitance responsive to the touch object being greater than the sensing threshold, so as to compute the sensed area associated with the touch object.

For instance, the sensed area 135 of FIG. 2 represents the area sensed by the touch panel 13 when a stylus touches the touch panel 13, wherein the sensed area 135 of FIG. 2 includes approximately 3 sensing points. The sensed area 137 of FIG. 2 represents the area sensed by the touch panel 13 when a finger of the user touches the touch panel 13, wherein the sensed area 137 of FIG. 2 includes approximately 18 sensing points.

The sensing threshold may be configured according to the level of noise interference on the touch panel 13. The sensing threshold may be for example, set to be 100 for preventing the touch panel 13 from making false detections under the influence of the change of capacitance due to ambient noises and/or water drop. The sensing threshold may also be configured according to the actual change of the capacitance associated with the sensing points 133 generated as the finger or the stylus contacts or touches the touch panel 13. For instance, the sensing threshold may be a value lying between 100 and 300 for identifying that the touch object may be a stylus or a finger.

The control unit 15 is configured to execute a built-in application program (e.g., a drawing application program or a writing application program) of the electronic device 1 and to correspondingly control the operations of the display 11, the touch panel 13, and the memory unit 17 according to the execution of the built-in application program.

The control unit 15 causes the electronic device 1 to operate in a graphic editing mode upon starting up the built-in application program. While the electronic device 1 operates in the graphic editing mode, the control unit 15 operatively compares the sensed area sensed by the touch panel 13 with a predefined area threshold according to the sensing information received from the touch panel 13. The control unit 15 thereafter determines the operation of the electronic device 1 (i.e., the function to be executed by the electronic device 1) under the graphic editing mode according to the comparison result.

When the control unit 15 determines that the sensed area is smaller than the predefined area threshold, the control unit 15 causes the electronic device 1 to execute a first function under the graphic editing mode according to an operation performed on the touch panel 13 by the touch object. On the other hand, when the control unit 15 determines that the sensed area is larger than the predefined area threshold, the control unit 15 causes the electronic device 1 to execute a second function under the graphic editing mode according to the operation performed on the touch panel 13 by the touch object.

The scenario where the control unit 15 determines that the sensed area is larger than the predefined area threshold may be, when the user touches the electronic device 1 with a touch object having a relatively large contact area, e.g., the finger pulp, or the tail-end of the stylus or the user increases the contact area between the tip of the stylus and the touch panel 13 by exerting pressure on the stylus. In other words, the user of electronic device 1 may be free to use any other suitable touch object or any suitable method touching the touch panel 13, so long as the type of the touch object or the forced exerted on the touch object would result in the sensed area sensed by the touch panel 13 being larger than the predefined area threshold, thus the present disclosure is not limited thereto.

More specifically, while the control unit 15 executes the first function (e.g., the drawing function or the writing function) under the graphic editing mode, the control unit 15 operatively causes the display 11 to display a graphic trace or a stroke according to the operation (e.g., a touch trace) performed on the touch panel 13 by the touch object. While the control unit 15 executes the second function under the graphic editing mode, the control unit 15 operatively clears a screen or a portion of the screen presently shown on the display 11 according to the operation performed on the touch panel 13 by the touch object. Particularly, the control unit 15 correspondingly clears the respective display region shown on the display 11 according to the touch trace of the touch object.

The predefined area threshold is used by the electronic device 1 as the basis for determining whether to execute the first function or the second function and the predefined area threshold may be configured according to the contact area between the stylus or the finger and the touch panel 13. In one embodiment, the predefined area threshold may be configured according to the minimum area (e.g., 5 sensing points) sensed by the touch panel 13 when touched by a finger (e.g., the finger pulp).

When the user operates the electronic device 1 with a stylus, the sensed area sensed by the touch panel 13 will be smaller than the predefined area threshold, and therefore the control unit 15 causes the electronic device 1 to execute the first function. On the contrary, when the user operates the electronic device 1 with a finger or a touch object having a relatively large contact area, the sensed area sensed by the touch panel 13 will be larger than the predefined sense threshold, and therefore the control unit 15 causes the electronic device 1 to execute the second function. Based on the above elaborations, those skilled in the art should be able to define an appropriate predefined area threshold and cause the electronic device 1 to selectively execute the first or the second function based on the user's operation manner.

For instance, suppose the predefined area threshold is set to be 5 sensing points. When the touch panel 13 senses the sensed area 135, the control unit 15 operatively determines that the user is operating the electronic device 1 with the stylus and executes the first function (e.g., the writing function or the drawing function) under the graphic editing mode. When the touch panel 13 senses the sensed area 137, the control unit 15 determines that the user is operating the electronic device 1 with the finger of the user and executes the second function (e.g., a clear function, a selection function, or a zoom-in function) under the graphic editing mode.

It worth to note that those skilled in the art should understand that the operation of the control unit 15 executing the first or the second function, and the operation of the control unit 15 causing the electronic device 1 to execute the first or the second function are the same in the present disclosure and therefore are used interchangeably throughout the entire context of the present disclosure.

The memory unit 17 is configured to store codes for the application program and the related execution data, for the control unit 15 to read therefrom and execute the application program. The memory unit 17 further may be used to store the sensing threshold, the predefined area threshold as well as the sensing information associated with the touch object including but not limited to the touch coordinate data and the sensed area computed.

In the instant embodiment, the control unit 15 may further drive the electronic device 1 to execute the second function concurrently while executing the first function according to the user's operation with the electronic device 1.

More specifically, when a touch event occurred on the electronic device 1 is determined to be triggered by the user with a first touch object (e.g., a stylus) or a second touch object (e.g., a finger) while the electronic device 1 is executing the first function, the control unit 15 automatically drives the electronic device 1 to switch from executing the first function to executing the second function upon determining that the sensed area sensed by the touch panel 13 is larger than the predefined area threshold. Moreover, when the first touch object (e.g., the stylus) has not been removed from the touch panel 13 and the sensed area generated responsive to the touch of the second touch object sensed by the touch panel 13 is larger than the predefined area threshold while the electronic device 1 executes the first function, the control unit 15 causes the electronic device 1 to execute the second function according to the operation performed on the touch panel 13 by the second touch object.

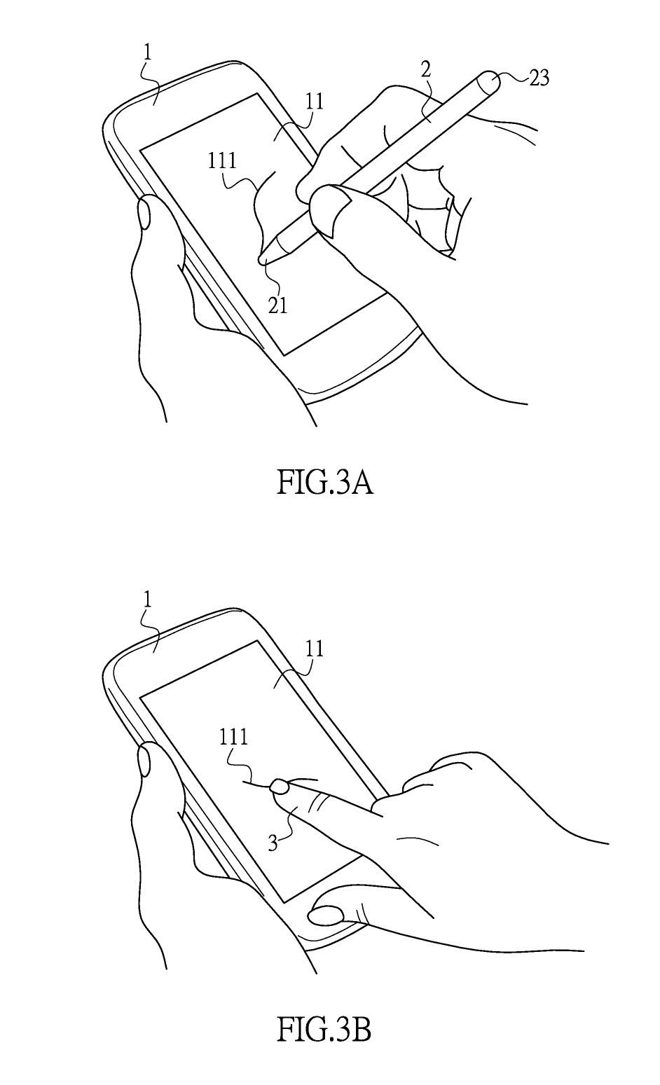

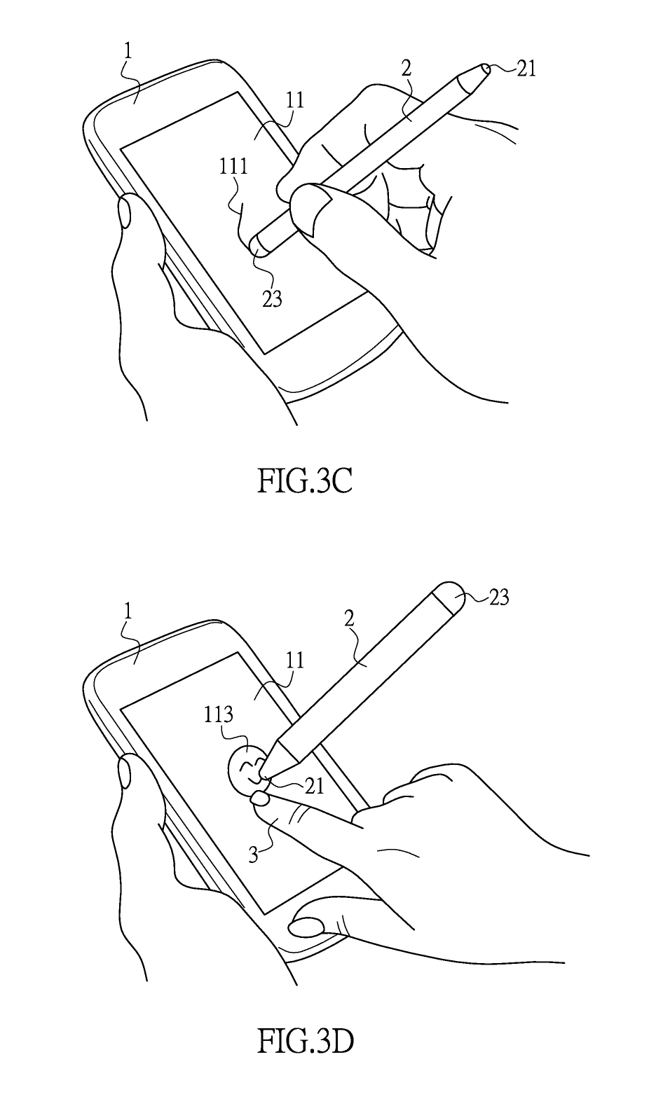

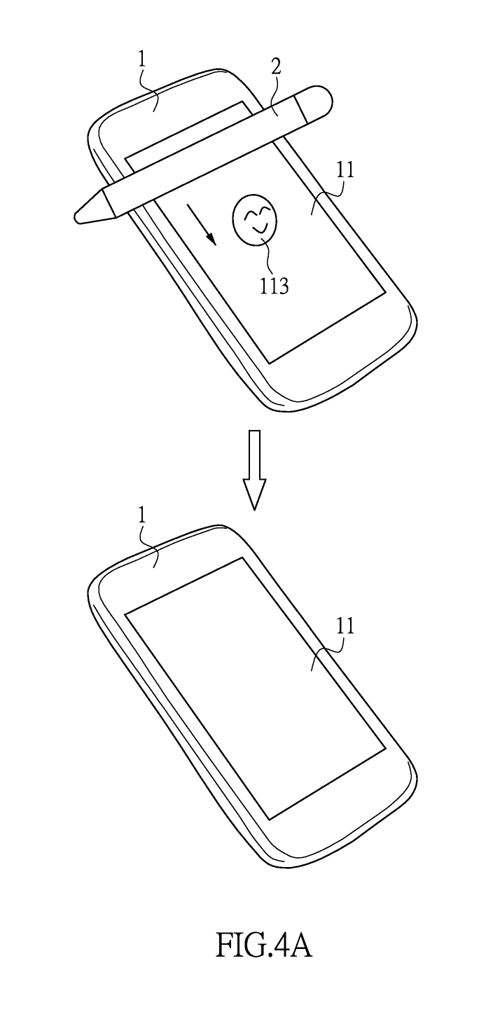

Details regarding the operation of the electronic device 1 are provided in the subsequent paragraph. Please refer to FIG. 3A-FIG. 3D in conjunction with FIG. 1 and FIG. 2. FIG. 3A-FIG. 3D are diagrams respectively illustrating operations of an electronic device provided in accordance to an exemplary embodiment of the present disclosure.

FIG. 3A depicts that the user of the electronic device 1 is operating the display 11 with a stylus 2. The touch panel 13 operatively generates and outputs the sensing information associated with the stylus 2 to the control unit 15 upon detecting an occurrence of a touch event. The sensed area of the sensing information is the contact area between a tip 21 of the stylus 2 and the touch panel 13, and the sensed area will be smaller than the predefined area threshold. Therefore, the control unit 15 causes the electronic device 1 to execute the first function (e.g., the writing function) under the graphic editing mode. The control unit 15 causes the display 11 to display a graphic trace 111 (e.g., a stroke) responsive to a touch trace associated with the stylus 2 sensed by the touch panel 13.

FIG. 3B describes a touch event triggered by a finger 3 of the user of the electronic device 1, in particular, describing the situation of while the electronic device 1 executes the first function, the user switches from using the stylus 2 to using the finger 3 and performs an operation on the display 11 (e.g., the user switches from a stylus operation to a finger operation), accordingly. The sensed area of FIG. 3B is the contact area between the finger 3 and the touch panel 13, and the sensed area (e.g., the sensed area 137 illustrated in FIG. 2) will be larger than the predefined area threshold. Therefore, the control unit 15 operatively causes the electronic device 1 to switch from executing the first function to executing the second function (e.g., the clear function) under the graphic editing mode. That is, the control unit 15 operatively causes the electronic device 1 to clear a portion of the screen shown on the display 11, e.g., clears a portion or the entire graphic trace 111 according to the touch position and the touch trace associated with the finger 2 sensed by the touch panel 13.

FIG. 3C describes a touch event triggered by the stylus 2, in particular, describing the situation of while the electronic device 1 executes the first function, the user switches from using the tip 21 of the stylus 2 to using the other end of the stylus 2 opposite to the tip 21 of the stylus 2 (i.e., using a tail-end 23 of the stylus 2) and performs an operation on the display 11, accordingly. The tail-end 23 of the stylus 2 herein is a conductor and has a relatively large contact area in comparison to the tip 21 of the stylus 2. The sensed area of FIG. 3C is the contact area between the tail-end 23 of the stylus 2 and the touch panel 13, and the sensed area will be larger than the predefined area threshold. The control unit 15 therefore causes the electronic device 1 to switch from executing the first function to executing the second function (e.g., the clear function) under the graphic editing mode as the sensed area is larger than the predefined area threshold. That is, the control unit 15 operatively causes the electronic device 1 to correspondingly clear a portion of the screen shown on the display 11 according to the touch trace associated with the tail-end 23 of the stylus 2 sensed by the touch panel 13.

FIG. 3D describes a touch event triggered by the stylus 2 and the finger 3, simultaneously. Specifically, while the electronic device 1 executes the first function, the user of electronic device 1 performs operations on the display 11 with both the stylus 2 and the finger 3 at same time. As illustrated in FIG. 3D, a first sensed area sensed by the touch panel 13 is the contact area between the stylus 2 and the touch panel 13, and a second sensed area sensed by the touch panel 13 is the contact area between the finger 3 and the touch panel 13. Specifically, the first sensed area will be smaller than the predefined area threshold, while the second sensed area will be larger than the predefined area threshold. Accordingly, the control unit 15 operatively drives the electronic device 1 to execute the first function according to the operation performed on the touch panel 13 by the stylus 2, e.g., causes the display 11 to display the graphic trace for forming a graphic symbol 113. The control unit 15 at the same time drives the electronic device 1 to execute the second function according to the operation performed on the touch panel 13 by the finger 3, i.e., causes the display 11 to clear the portion of the screen shown on the display 11 corresponding to the touch trace of the finger 3 (e.g., clears a portion of the graphic trace of the graphic symbol 113).

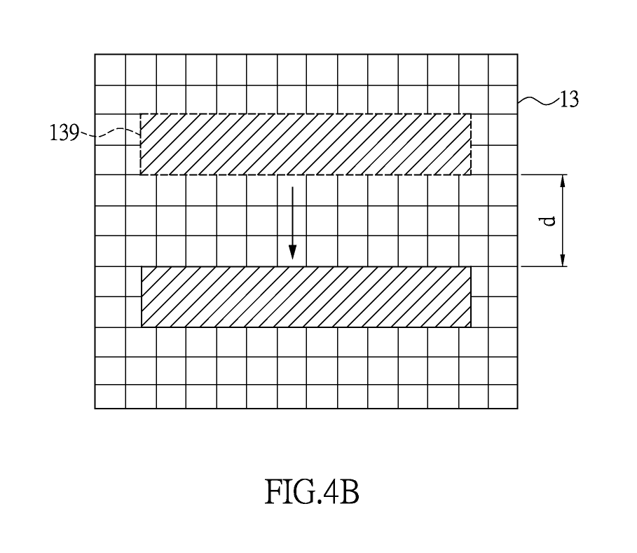

Additionally, the electronic device 1 of the present disclosure is further operable to operatively clear the entire screen presently shown on the display 11 based on the contact area between the touch object and the touch panel and the touch trace of the touch object detected. Please refer to FIG. 4A and FIG. 4B in conjunction with FIG. 1. FIG. 4A shows a diagram illustrating the touch operation of an electronic device provided in accordance to an exemplary embodiment of the present disclosure. FIG. 4B shows a diagram illustrating an operation of a touch panel provided in accordance to the exemplary embodiment of the present disclosure.

While the electronic device 1 operates in the graphic editing mode, the control unit 15 operatively detects whether the touch trace associated with the touch object matches a predefined trace upon determining that the sensed area generated responsive to capacitive coupling between the touch object and the touch panel 13 is larger than the predefined area threshold. When the control unit 15 detects that the touch trace associated with the touch object matches the predefined trace (e.g., moves a predefined distance along a specific direction), the control unit 15 operatively determines that the touch trace associated with the touch object matches a predefined gesture and causes the display 11 to clear the screen presently shown thereon.

For instance, the control unit 15 may detect the touch trace associated with the touch operation performed by the touch object on the touch panel 13 upon determining that the sensed area is larger than the predefined area threshold, i.e., detects the moving direction of the touch object on the touch panel 13 and the displacement of the touch object relative to the touch panel 13 as illustrated in FIG. 4B. Specifically, when the control unit 15 determines that the moving direction of the touch object on the touch panel 13 matches a predefined moving direction (e.g., moving on the touch panel 13 in a downward direction) and the displacement of the touch object is greater than or equal to a predefined distance d (e.g., 5 sensing points), the control unit 15 determines that the touch trace of the touch object matches the predefined gesture and instantly causes the display 11 to clear the screen presently shown thereon.

In a concrete embodiment, when the control unit 15 determines that the sensed area generated responsive to the capacitive coupling between the touch object and the touch panel 13 is larger than the predefined sensed area and the touch trace of the touch object detected matches the predefined trace or the predefined gesture while executing the built-in application program (e.g., the drawing application or the writing application), the built-in application program generates or sets a clear flag. When the control unit 15 detects the presence of the clear flag, the control unit 15 instantly causes the display 11 to clear the screen presently shown thereon.

It is worth to note that the control unit 15 may be implemented by a processing chip programmed with the necessary firmware. The processing chip can include but is not limited to a microcontroller, or an embedded controller, however the present disclosure is not limited to the example provided herein. The memory unit 17 can be implemented by a volatile or a non-volatile memory such as a flash memory, a read only memory, or a random access memory, and the present disclosure is not limited to the example provided herein.

It should be noted that the exact type, the exact structure, and/or the implementation method associated with the display 11, the touch panel 13, the control unit 15, and the memory unit 17 may vary according to the exact type, the specific design structure and/or implementation method associated with the electronic device 1, and the present discourse is not limited thereto. In other words, FIG. 2 and FIG. 4A merely used to illustrate operations of the touch panel 13, and should be used to limit the scope of the present discourse. Similarly. The operating method of the electronic device 1 described in FIG. 3A-FIG. 3D as well as FIG. 4B are merely used for illustrations, and should be used to limit the scope of the present discourse.

(An Exemplary Embodiment a Graphic Editing Method)

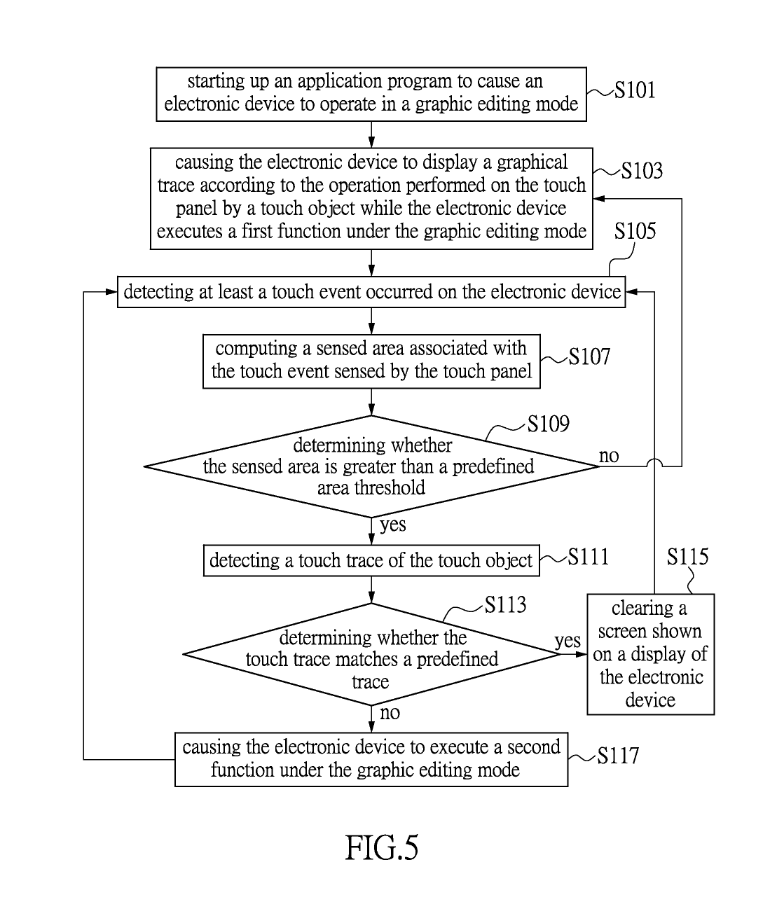

From the aforementioned exemplary embodiments, the present disclosure can generalize a graphic editing method, which may be adapted to the aforementioned electronic device having a touch panel. Please refer to FIG. 5 in conjunction with FIG. 1, wherein FIG. 5 shows a flowchart diagram illustrating a graphic editing method provided in accordance to an exemplary embodiment of the present disclosure.

In Step S101, the control unit 15 of the electronic device 1 starts up a built-in application program in the electronic device 1 to cause the electronic device 1 to operate in a graphic editing mode. The application program in the instant embodiment may be a drawing application program or a writing application program, although the present disclosure is not limited thereto.

In Step S103, the control unit 15 executes a first function (e.g., the writing function) under the graphic editing mode according to the operation performed on the touch panel 13 by a touch object (e.g., a stylus), so as to cause the display 11 of the electronic device 1 to display a graphic trace (e.g., the graphic trace 111 shown in FIG. 3A) corresponding to the operation performed on the touch panel 13 by the touch object.

In Step S105, the touch panel 13 detects at least a touch event occurred on the electronic device 1 for the control unit 15 to correspondingly control the operation of the electronic device 1 according to the touch event.

In Step S107, when the touch panel 13 detects an occurrence of a touch event, computing a sensed area associated with the touch object (e.g., the stylus or the finger of the user) sensed by the touch panel 13. To put it concretely, when the touch object causes a change in capacitance of a plurality of sensing points on the touch panel 13, the touch panel 13 determines that a touch event has occurred on the electronic device 1 and generates a sensing information, accordingly. At the same time, the control unit 15 obtains the sensed area associated with the touch event by computing the number of sensing points having the change in capacitance responsive to the touch object being greater than a sensing threshold and computes touch position of the touch object relative to the touch panel 13 according to the sensing information outputted by the touch panel 13.

In Step S109, the control unit 15 determines whether the sensed area computed is larger than a predefined area threshold. When the control unit 15 determines that the sensed area is larger than the predefined area threshold, the control unit 15 executes Step S111; otherwise, the control unit 15 returns to Step S103.

In Step S111, the touch panel 13 detects a touch trace of the touch object and generates the sensing information containing the touch trace data, for the control unit 15 to determine whether or not to cause the electronic device 1 to execute a third function under the graphic editing mode, e.g., screen clear function.

In Step S113, the control unit 15 determines whether the touch trace of the touch object matches a predefined trace or a predefined gesture.

When the control unit 15 determines that the touch trace generated corresponding to the operation of the touch object on the touch panel 13 matches the predefined trace or the predefined gesture, the control unit 15 executes Step S115. On the contrary, when the control unit 15 determines that the touch trace generated corresponding to the operation of the touch object on the touch panel 13 does not match the predefined trace or the predefined gesture, the control unit 15 executes Step S117.

In Step S115, the control unit 15 drives the electronic device 1 to execute the third function under the graphic editing mode, i.e., the screen clear function. To put it concretely, the control unit 15 drives the electronic device 1 to clear the screen presently shown on the display 11.

In Step S117, the control unit 15 executes a second function under the graphic editing mode, i.e., the clear function. That is, the control unit 15 correspondingly clears a portion of the screen shown on the display 11 according to the touch trace of the touch object or another touch object.

It is worth to note that the instant embodiment takes the first function as the writing function and the second function as the clear function for illustration purposes. In other embodiments, the second function may be a selection function (e.g., selecting a display object or a graphic trace) or a zoom-in function. More specifically, while the control unit 15 executes the second function, the control unit 15 may select a display object on the screen corresponding to the touch position or zoom-in the display region corresponding to the touch position according to the touch position of the touch object on the touch panel 13. Moreover, the first function may also be configured to execute another type of function including but not limited to selecting a specific display region or a specific display object and displaying a menu. In other words, the first function and the second function may be configured according to operation and/or application requirements by the user of the electronic device 1 or the designer of the application program, and the present disclosure is not limited thereto.

Additionally, when the touch panel 13 detects another touch event triggered by another touch object has occurred on the electronic device 1 while the control unit 15 is executing the first function, the control unit 15 may execute the Steps S107-S109 of detecting the sensed area associated with the another touch event and determining the size of the sensed area. The control unit 15 may further cause the electronic device 1 to simultaneously execute the first function and the second function upon determining that the sensed area associated with the another touch event is larger than the predefined area threshold.

It should be noted that FIG. 5 is merely used to illustrate an implementation of the graphic editing method and should not be used to limit the scope of the present disclosure.

(Another Exemplary Embodiment a Graphic Editing Method)

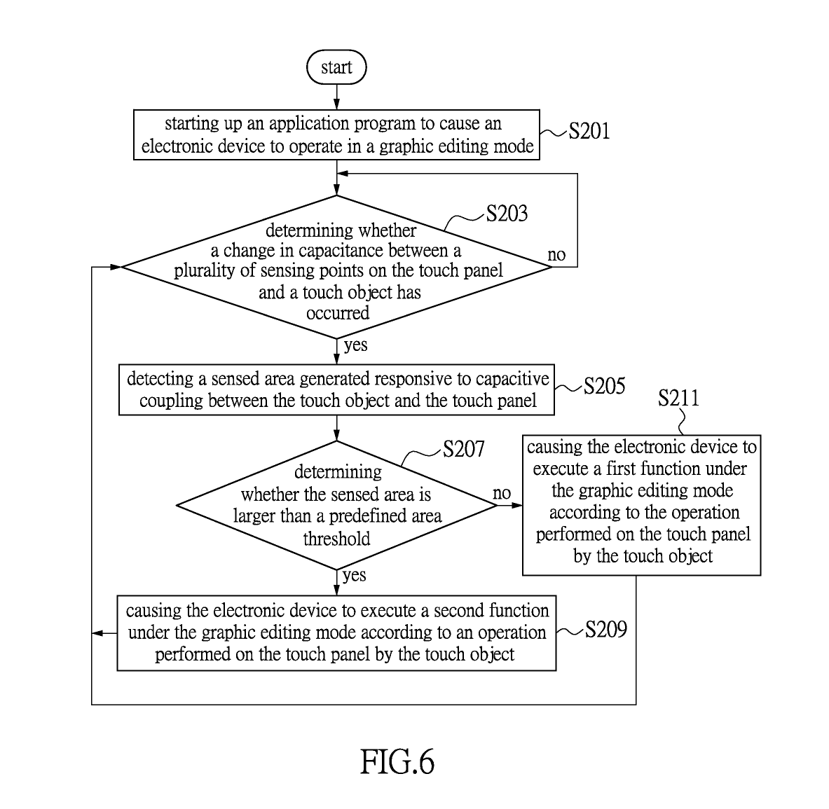

From the aforementioned exemplary embodiments, the present disclosure can also generalize another graphic editing method, which may be adapted to the aforementioned electronic device having a touch panel. Please refer to FIG. 6 in conjunction with FIG. 1, wherein FIG. 6 shows a flowchart diagram illustrating a graphic editing method provided in accordance to another exemplary embodiment of the present disclosure.

In Step S201, the control unit 15 starts up a built-in application program of the electronic device 1 to cause the electronic device 1 to operate in a graphic editing mode. Subsequently, in Step S203, the touch panel 13 operatively detects whether a touch event has occurred on the electronic device 1 by determining whether a change in capacitance between a plurality of sensing points on the touch panel 13 and a touch object has occurred.

More specifically, when the touch panel 13 determines that the change in capacitance between the plurality of sensing points on the touch panel 13 and the touch object is greater than a sensing threshold, the touch panel 13 executes Step S205. When the touch panel 13 determines that the capacitance of the plurality of sensing points on the touch panel 13 experiences no change or the change in capacitance between the plurality of sensing points on the touch panel 13 and the touch object is less than or equal to the sensing threshold, the touch panel 13 determines that the touch event is triggered by noise and returns to Step S203.

In Step S205, a sensed area generated responsive to capacitive coupling between the touch object and the touch panel 13 and the associated touch position of the touch object is sensed by the touch panel 13 to generate a sensing information. Particularly, the sensed area can be obtained by computing the number of the plurality of sensing points on the touch panel 13 having the change in capacitance responsive to the touch object being greater than the sensing threshold.

The sensing threshold herein can be a predefined capacitance sensing value. The sensing threshold can be configured according to the level of noise interference on the touch panel 13 and/or the minimum change of the capacitance of the sensing points generated as the touch object contacts the touch panel 13, for preventing the touch panel 13 from making false detections under the influence of the change in capacitance due to ambient noises and/or a water drop.

In Step S207, the control unit 15 determines whether the sensed area is larger than the predefined area threshold according to the sensing information received from the touch panel 13. When the control unit 15 determines that the sensed area is larger than the predefined area threshold according to the sensing information received, the control unit 15 executes Step S209; otherwise, the control unit 15 executes Step S211.

In Step S209, the control unit 15 causes the electronic device 1 to execute a second function under the graphic editing mode according to an operation performed on the touch panel 13 by the touch object. In Step S211, the control unit 15 causes the electronic device 1 to execute a first function under the graphic editing mode according to the operation performed on the touch panel 13 by the touch object.

When the control unit 15 causes the electronic device 1 to execute the first function, the electronic device 1 operatively displays a graphical trace or a stroke according to the operation performed on the touch panel 13 by the touch object. When the control unit 15 causes the electronic device 1 to execute the second function, the electronic device 1 operatively clears a screen or a portion of the screen shown on the display 11 of the electronic device according to the operation performed on the touch panel 13 by the touch object.

In the instant embodiment, after the control unit 15 executed Step S209 or S211, the control unit 15 operatively returns to Step S203 and continues to drive the touch panel 13 to detect whether or not a touch event has occurred on the electronic device 1.

It is worth to note that when the control unit 15 determines that the sensed area generated responsive to the capacitive coupling between the touch object and the touch panel 13 is larger than the predefined area threshold while the electronic device 1 executes the first function, the control unit 15 can automatically drive the electronic device 1 to switch from executing the first function to executing the second function.

In another embodiment, before executing Step S209, the control unit 15 may further detect a touch trace of the touch object after determining that the sensed area generated responsive to the capacitive coupling between the touch object and the touch panel 13 is larger than the predefined area threshold. Particularly, the control unit 15 may cause the electronic device 1 to clear the screen shown on the display 11 when the control unit 15 determines that the touch trace associated with the touch object matches a predefined trace or a predefined gesture.

It should be noted that FIG. 6 is merely used to illustrate an implementation of the graphic editing method and should not be used to limit the scope of the present disclosure.

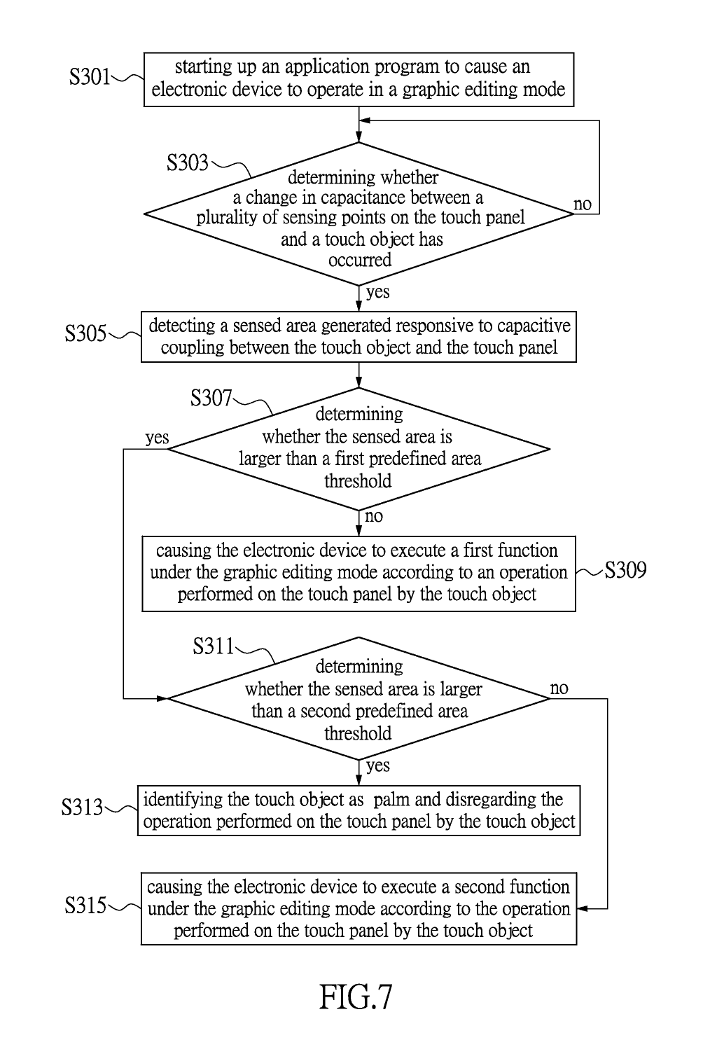

Additionally, the graphic editing method of FIG. 6 may be implemented by programming the necessary program codes and causing the control unit 15 to execute the program codes, accordingly during the operation of the electronic device 1. Or the graphic editing method of FIG. 6 may be implemented by directly programming the corresponding program codes into a processing chip configured as the control unit 15 via firmware design. That is, the instant embodiment does not limit the implementation method illustrated in FIG. 7.

(Another Exemplary Embodiment a Graphic Editing Method)

It is commonly known in the art that inadvertent contact or palm-touch input often leads to false readings of touch-input causing false operation and a difficult user experience while the user operates the electronic device. Thus, the present disclosure further provides a mechanism for identifying and discriminating touch inputs resulting from inadvertent contact or palm contact based on the size of a sensed area sensed by a touch panel of an electronic device, thereby enhancing the user's operation experience.

Please refer to FIG. 7 in conjunction with FIG. 1. FIG. 7 shows a flowchart diagram illustrating a graphic editing method provided in accordance to another exemplary embodiment of the present disclosure.

In Step S301, the control unit 15 starts up a built-in application program of the electronic device 1 to cause the electronic device 1 to operate in a graphic editing mode. The application program in the instant embodiment may be a drawing application program or a writing application program, although the present disclosure is not limited thereto.

In Step S303, the touch panel 13 operatively detects whether a touch event has occurred on the electronic device 1 by determining whether a change in capacitance between a plurality of sensing points on the touch panel 13 and a touch object has occurred. The touch object includes but not limited to a stylus or a finger of the user.

When the touch panel 13 determines that the change in capacitance between the plurality of sensing points on the touch panel 13 and the touch object is greater than a sensing threshold, the touch panel 13 executes Step S305; otherwise, the touch panel 13 returns to Step S303 and continues to detect whether the change in capacitance between a plurality of sensing points on the touch panel 13 and the touch object has occurred.

In Step S305, the touch panel 13 detects a sensed area generated responsive to capacitive coupling between the touch object and the touch panel 13 and generates a sensing information, accordingly, wherein the sensing information at least includes the sensed area sensed by the touch panel 13 after the touch event has occurred on the electronic device 1. The sensed area is the number of the plurality of sensing points on the touch panel 13 having the change in capacitance responsive to the touch object being greater than the sensing threshold.

It is worth to note that the sensing threshold herein is a predefined capacitance sensing value and may be configured according to the noise level of the touch panel 13 and/or the minimum change in the capacitance of the sensing points generated as the touch object contacts the touch panel 13.

In Step S307, the control unit 15 determines whether the sensed area is larger than a first predefined area threshold to determine the size of the touch object according to the sensing information received from the touch panel 13. When the control unit 15 determines that the sensed area is larger than the first predefined area threshold, the control unit 15 executes Step S311; otherwise, the control unit 15 executes Step S309. The first predefined area threshold may be configured based on the actual contact area between the touch object (e.g., the stylus or the finger of the user) and the touch panel 13.

In Step S309, the control unit 15 causes the electronic device 1 to execute a first function under the graphic editing mode according to an operation performed on the touch panel 13 by the touch object after the control unit 15 determined that the touch object is a small-size touch object such as a tip of the stylus or the fingertip. While the electronic device 1 executes the first function, the control unit 15 operatively causes the display 11 of the electronic device 1 to display a graphic trace or the stroke on the screen thereof according to the operation (e.g., a stroke operation) performed on the touch panel 13 by the touch object.

In Step S311, the control unit 15 next determines whether the sensed area is larger than a second predefined area threshold (referred to as an input rejection threshold) after the control unit 15 determined that the touch object is a bigger-size touch object, e.g., a tail-end of a stylus or a finger pulp, or a palm, so as to determine whether the touch event is valid, wherein the second predefined area threshold is larger than the first predefined area threshold. In one embodiment, the second predefined area threshold may be configured according to an average human palm size and the first predefined area threshold.

When the control unit 15 determines that the sensed area is larger than the second predefined area threshold, indicating that the touch input sensed by the touch panel 13 is an invalid touch input, i.e., the touch input sensed by the touch panel 13 is caused by an inadvertent touch or a palm touch, therefore, the control unit 15 executes Step S313.

On the contrary, when the control unit 15 determines that the sensed area is smaller than the second predefined area threshold, indicating that the touch input sensed by the touch panel 13 is a valid touch input, i.e., the touch input sensed by the touch panel 13 is caused by an intended touch made by the user using the touch object having a relative bigger size, such as the tail-end of the stylus or the finger pulp, and the control unit 15 executes Step S315 thereafter.

In Step S313, the control unit 15 identifies the touch object as a palm, and operatively disregards the touch event associated with the touch object and the operation performed on the touch panel 13 by the touch object, i.e., disregards the touch input made by the touch object.

In Step S315, the control unit 15 causes the electronic device 1 to execute a second function under the graphic editing mode according to the operation performed on the touch panel 13 by the touch object. While the electronic device 1 executes the second function, the control unit 15 operatively clears a screen or a portion of screen shown on the display 11 of the electronic device 1 based on the operation performed on the touch panel 13 by the touch object.

It is worth to mention that when multiple simultaneous touch events occur on the electronic device 1, the control unit 15 is operable to identify one or more invalid touch events from those valid touch events and disregards one or more invalid touch events identified according to the sensed area associated with each respective touch event, thereby enhancing the performance of the touch panel 13 and at same time improving a user's operation experience with the electronic device 1.

Incidentally, after the control unit 15 has determined that the sensed area is larger than the first predefined area threshold while smaller than the second predefined area threshold, the control unit 15 may further determine a touch trace associated with the touch object. More specifically, the control unit 15 determines whether the touch trace of the touch object matches a predefined trace or a predefined gesture. When the control unit 15 determines that the touch trace of the touch object matches the predefined trace or the predefined gesture, the control unit 15 clears the screen shown on the display 11 of the electronic device 1.

The graphic editing method of FIG. 7 may be implemented by programming the corresponding program codes into a processing chip configured as the control unit 15 via firmware design and executed by the control unit 15 during the operation of the electronic device 1.

Moreover, in another implementation, Step S307 and Step S311 may be integrated into one single step. In particular, when the control unit 15 determines that the sensed area is smaller than the first predefined area threshold, the control unit 15 executes Step S309 and causes the electronic device 1 to execute the first function; when the control unit 15 determines that the sensed area is larger than the first predefined area threshold while smaller than the second predefined area threshold, the control unit 15 executes Step S315 and causes the electronic device 1 to execute the second function; when the control unit 15 determines that the sensed area is larger than the second predefined area threshold, the control unit 15 executes Step S313, identifies the touch object as a palm, and disregards the operation made by touch object on the touch panel 13. That is to say, the exact implementation used for verifying the touch object based on the size of the sensed area may depend upon the practical operation requirements of the electronic device 1 and those skilled in the art should able to select the appropriate implementation based on the needs.

It shall be noted that FIG. 7 is merely used to illustrate a graphic editing method and FIG. 7 shall not be used to limit the scope of the present disclosure.

(Another Exemplary Embodiment a Graphic Editing Method)

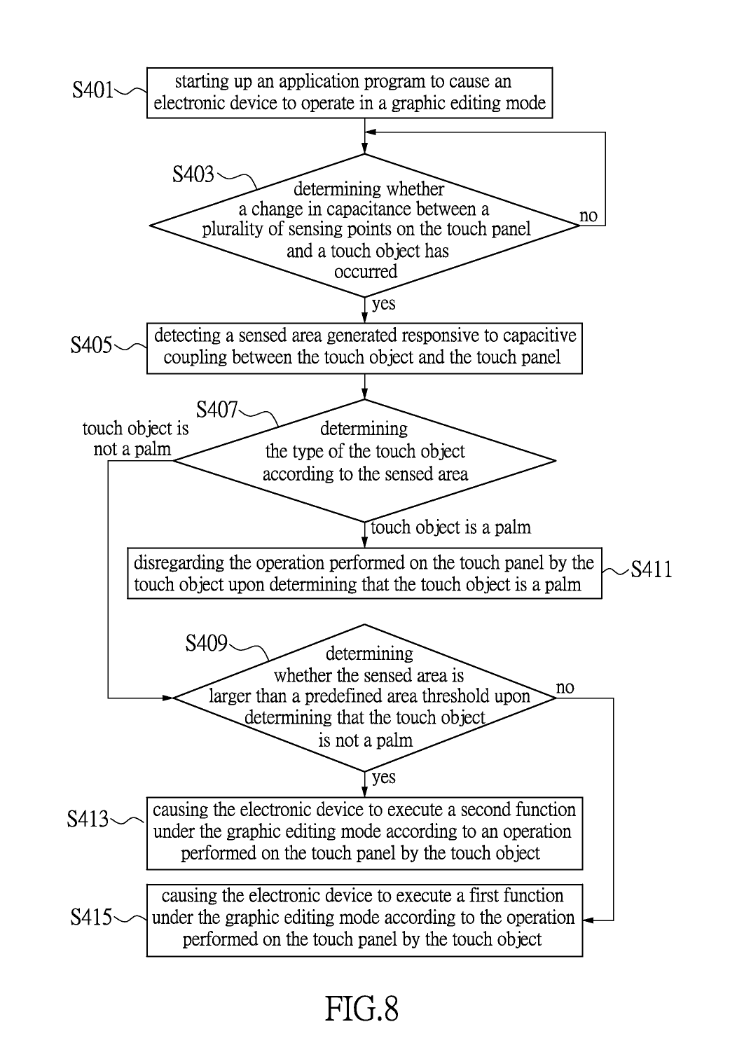

From the aforementioned exemplary embodiments, the present disclosure can generalize another graphic editing method for the aforementioned electronic device having a touch panel. Please refer to FIG. 8 in conjunction with FIG. 1. FIG. 8 shows a flowchart diagram illustrating a graphic editing method provided in accordance to another exemplary embodiment of the present disclosure.

The graphic editing method of FIG. 8 can be implemented by programming the control unit 15 via firmware design and executed by the control unit 15 during the operation of the electronic device 1.

In Step S401, the control unit 15 starts up a built-in application program of the electronic device 1 to cause the electronic device 1 to operate in a graphic editing mode. The application program in the instant embodiment may be a drawing application program or a writing application program, although the present disclosure is not limited thereto.

In Step S403, the touch panel 13 operatively detects whether a change in capacitance between a plurality of sensing points on the touch panel 13 and a touch object has occurred, i.e., whether a touch event has occurred on the electronic device 1. The touch object includes but is not limited to a stylus or a finger of the user.

Particularly, when the touch panel 13 determines that the change in capacitance between the plurality of sensing points on the touch panel 13 and the touch object is greater than a first sensing threshold, the touch panel 13 executes Step S405; otherwise, the touch panel 13 returns to Step S403. The first sensing threshold herein is a predefined capacitance sensing value configured according to the level of noise interference on the touch panel 13 and/or the minimum change in the capacitance associated with the sensing points generated as the touch object contacts the touch panel 13.

In Step S405, the touch panel 13 detects a sensed area generated responsive to capacitive coupling between the touch object and the touch panel 13 and generates a sensing information, accordingly, wherein the sensing information at least includes the sensed area sensed by the touch panel 13 after the touch event has occurred on the electronic device 1. As described previously, the sensed area is the number of the plurality of sensing points on the touch panel 13 having the change in capacitance responsive to the touch object being greater than the first sensing threshold.

In Step S407, the control unit 15 determines the type of the touch object according to the sensing information received from the touch panel 13 i.e., determines whether the touch event that occurred on the electronic device 1 is trigged by an intended touch or an inadvertent touch, to discriminate inadvertent contacts like palm contact and to prevent the false operation of the electronic device 1. In particular, the control unit 15 determines the type of the touch object according to the sensed area. When the control unit 15 identifies the touch object as a palm, the control unit 15 executes Step S411; otherwise, the control unit 15 executes Step S409.

Since the sensed area generated responsive to a palm touch generally will be larger than the sensed area generated responsive to a touch made by a stylus or a finger due to natural profiles of the human palm, the stylus, and the human finger, in one embodiment, the control unit 15 may determine the type of the touch object based on the size of the sensed area associated with the touch object. More specifically, the control unit 15 may compare the sensed area with an input rejection threshold that corresponds to the average human palm size. When the control unit 15 determines that the sensed area is larger than the input rejection threshold, the control unit 15 immediately identifies the touch object as a palm and the touch event is triggered by an inadvertent touch or a palm touch.

Moreover, as a finger or a stylus generally has a localized effect on the touch panel 13 while a palm touch has a more uniform effect on a larger number of sensing points due to the natural profiles of a stylus, a human finger, and a human palm, in another embodiment, the sensing information generated outputted by the touch panel 13 may include the sensed area, a central area of the sensed area (referring to the physical contact or the touch area between the touch object and the touch panel 13), and a peripheral area of the sensed area (referring to the hover area of the touch object send by the touch panel 13). The control unit 15 then determines the type of the touch object based on the ratio between the central area and the peripheral area of the sensed area.

Generally speaking, the change of mutual capacitances associated with the sensed area from the perimeter to the center caused by the stylus or the finger will be relatively steep in comparison to the change of mutual capacitances associated with the sensed area from the perimeter to the center caused by a palm to the natural profiles of a stylus, a human finger, and a human palm.

Accordingly, when a finger of the user (e.g., the fingertip or the finger pulp) or a stylus (e.g., the tip or the tail-end of the stylus) is in contact with the touch panel 13, the ratio between the central area and the peripheral area of the sensed area will be greater than a predefined ratio threshold as the central area will be larger than the peripheral area. On the other hand, when a palm is in contact with the touch panel 13, the ratio between the central area and the peripheral area of the sensed area will be less than the predefined ratio threshold as the central area will be smaller than the peripheral area. It is worth to mention that the predefined ratio threshold herein can be configured based on the sensed area generated corresponding to the touch input made by a human palm, a human finger, and a stylus.

Hence, when the control unit 15 determines that the ratio between the central area and the peripheral area of the sensed area is less than the predefined ratio threshold, the control unit 15 can instantly identify the touch object as a palm, i.e., the touch event may be triggered by an inadvertent touch or a palm touch; when the control unit 15 determines that the ratio between the central area and the peripheral area of the sensed area is greater than the predefined ratio threshold, the control unit 15 identifies that the touch object as a stylus or a finger having a relative bigger size, i.e., the touch event is triggered by a stylus or a finger having a relative bigger size and not by a palm.

In one embodiment, the central area and the peripheral area of sensed area may be obtained by using the mutual-scan method. The central area is defined as the number of sensing points on the touch panel 13 having the change in the mutual-capacitance responsive to the touch object being greater than a second sensing threshold, wherein the second sensing threshold is greater than the first sensing threshold; the peripheral area is defined as the number of sensing points on the touch panel 13 having the change in mutual-capacitance responsive to the touch object being greater than the first sensing threshold while less than the second sensing threshold. The second sensing threshold can be a predefined capacitance sensing value configured according to the change in mutual capacitance sensed when the touch object is in contact with the touch panel 13.

Moreover, the control unit 15 may also determine the type of the touch object according to the width of the peripheral area. In particular, the control unit 15 may compare the width of the peripheral area with a predefined width threshold. When the control unit 15 determines that the width of the peripheral area is larger than the predefined width threshold, the control unit 15 identifies the touch object as a hovering palm; otherwise, the control unit 15 identifies the touch object as a stylus or a finger having a relative bigger size, such as the tail-end of the stylus, the finger pulp, or the like.

In another embodiment, the control unit 15 may determine the type of touch object according to the size of the sensed area, the size of the central area of the sensed area, and the peripheral area of the sensed area.

It should be noted that exemplary embodiments described in the instant embodiment are intended to generally detail possible implementations or algorithms used for identifying the type of touch object touching the touch panel 13 and other implementations are possible. Those skilled in the art should be able to select one or more appropriate implementations from among the above described implementation or other known method in the art for defining the central area and the peripheral area of the sensed area as well as identifying the type of touch object based on the practical application or operation requirement, and the present disclosure is not limited thereto.

In Step S409, the control unit 15 operatively determines whether the sensed area is larger than a predefined area threshold upon determining that the touch object is not a palm. That is, when the control unit 15 determines that the touch-input made by the touch object is a valid touch-input or an intended touch input, the control unit 15 then analyzes and determines whether to cause the electronic device 1 to execute a first function or a second function under the graphic editing mode based on the size of the sensed area associated with the touch object.

Particularly, when the control unit 15 determines that the sensed area is larger than the predefined area threshold, the control unit 15 executes Step S413; otherwise, the control unit 15 executes Step S415. The predefined area threshold can be configured based on the general contact area size of the proper touch object, such as the fingertip or the finger pulp, a tip and/or the tail end of the stylus.

In Step S411, the control unit 15 identifies the touch object as a palm and operatively disregards the operation performed on the touch panel 13 by the touch object. That is, the control unit 15 rejects the touch input made by the touch object upon identifying the touch object as a palm.

In Step S413, the control unit 15 causes the electronic device 1 to execute the second function under the graphic editing mode according to an operation performed on the touch panel by the touch object. While the electronic device 1 executes the second function, the control unit 15 operatively clears a screen or a portion of screen shown on the display 11 of the electronic device 1 according to the operation performed on the touch panel 13 by the touch object.

In Step S415, the control unit 15 causes the electronic device 1 to execute the first function under the graphic editing mode, i.e., causes the display 11 of the electronic device 1 to display a graphic trace or a stroke on the screen thereof according to the operation (e.g., a stroke operation) performed on the touch panel 13 by the touch object.

It shall be noted that FIG. 8 is merely used to illustrate an implementation of a graphic editing method, and therefore FIG. 8 should not be used to limit the scope of the present disclosure.

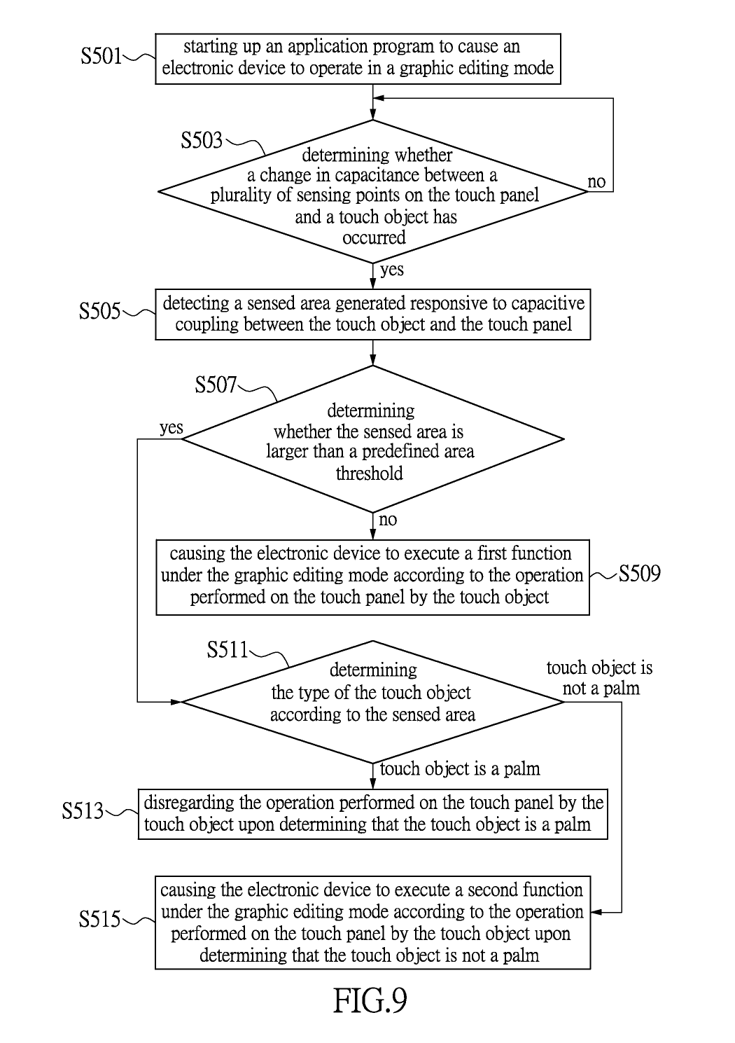

It is worth to note that Step S407 of determining the type of the touch object depicted in FIG. 8 may also be executed after Step S409. That is, the step of determining the type of the touch object may be executed after the step of determining whether the sensed area is larger than the predefined area threshold. Please refer to FIG. 9 in conjunction with FIG. 1. FIG. 9 shows a flowchart diagram illustrating a graphic editing method provided in accordance to another exemplary embodiment of the present disclosure.

In Step S501, the control unit 15 starts up an application program to cause an electronic device to operate in a graphic editing mode. In Step S503, the touch panel 13 operatively determines whether a change in capacitance between a plurality of sensing points on the touch panel 13 and a touch object has occurred, i.e., whether a touch event has occurred on the electronic device 1.

When the touch panel 13 determines that the change in capacitance between the plurality of sensing points on the touch panel and the touch object is greater than a first sensing threshold, the touch panel 13 executes Step S505; otherwise, the touch panel 13 executes Step S503.

In Step S505, the touch panel 13 detects a sensed area generated responsive to capacitive coupling between the touch object and the touch panel 13 and generates a sensing information. The sensing information at least includes a sensed area sensed by the touch panel 13 after the touch event has occurred on the electronic device 1.

In Step S507, the control unit 15 determines whether the sensed area is larger than a predefined area threshold according to the sensing information received from the touch panel 13. When the control unit 15 determines that the sensed area is larger than the predefined area threshold, the control unit 15 executes Step S511; otherwise, the control unit 15 executes Step S509.

In Step S509, the control unit 15 causes the electronic device 1 to execute a first function under the graphic editing mode, i.e., causes the display 11 of the electronic device 1 to display a graphic trace on the screen thereof according to an operation performed on the touch panel 13 by the touch object.

In Step S511, the control unit 15 determines the type of the touch object. When the control unit 15 determines that the touch object is a palm (i.e., the touch event is triggered by an inadvertent touch or a palm touch), the control unit 15 executes Step S513. On the contrary, when the control unit 15 determines that the touch object is not a palm (i.e., the touch event is triggered by a stylus or a finger having a relative bigger size), the control unit 15 executes 5515.

Those skilled in the art may configure the control unit 15 to determine the type of the touch object based on the size of the sensed area and/or the ratio between the central area of the sensed area and the peripheral area of the sensed area as described in aforementioned embodiments, hence further descriptions are hereby omitted.

In Step S513, the control unit 15 operatively identifies the touch object as a palm, regards the touch input as a palm touch, and disregards the operation performed on the touch panel 13 by the touch object. That is, the control unit 15 rejects the touch input made by the touch object upon determining that the touch object is a palm.

In Step S515, the control unit 15 causes the electronic device 1 to execute a second function under the graphic editing mode according to the operation performed on the touch panel by the touch object upon determining that the touch object is not a palm but a touch object having a relative bigger size.

Incidentally, the graphic editing method of FIG. 9 can be implemented by programming the control unit 15 via firmware design and executed by the control unit 15 during the operation of the electronic device 1.

It shall be noted that FIG. 9 is merely used to illustrate an implementation of a graphic editing method, respectively, hence FIG. 9 shall not be used to limit the scope of the present disclosure.

Additionally, the present disclosure also discloses a non-transitory computer-readable media for storing the computer executable program codes of the graphic editing method depicted in at least one of FIG. 5-FIG. 9. When the non-transitory computer readable recording medium is read by a processor, the processor operatively executes the aforementioned graphic editing method. The non-transitory computer-readable media may be a floppy disk, a hard disk, a compact disk (CD), a flash drive, a magnetic tape, accessible online storage database or any type of storage media having similar functionality known to those skilled in the art.

In summary, exemplary embodiments of the present disclosure provide a graphic editing method and an electronic device having a touch panel using the same. The graphic editing method can cause the electronic device to operatively execute the corresponding function (e.g., the writing function or the screen clear function) under the graphic editing mode according to the size of contact area between a touch object (e.g., a finger or a stylus) operated by a user and a touch panel of the electronic device sensed, so as to enable the electronic device to achieve the objective of performing a variety of functions in a single touch operation, thereby enhancing the operation convenience of the electronic device.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A graphic editing method for an electronic device having a touch panel and operating in a graphic editing mode, the graphic editing method comprising:
a) executing a first function to cause the electronic device to display a graphical trace according to an operation performed on the touch panel by a first touch object;
b) detecting at least a touch event occurred on the electronic device after step a) and computing a sensed area associated with the touch event sensed by the touch panel; and
c) comparing the sensed area with a first predefined area threshold and executing a second function under the graphic editing mode upon determining that the sensed area is larger than the first predefined area threshold.

2. The graphic editing method according to claim 1, further comprising:
d) executing the first function under the graphic editing mode upon determining that the sensed area is smaller than the first predefined area threshold.

3. The graphic editing method according to claim 1, wherein the first touch object is a stylus.

4. The graphic editing method according to claim 1, wherein the step after step b) comprises:
determining the type of the first touch object.

5. The graphic editing method according to claim 4, wherein the step of determining the type of the first touch object comprises:
determining whether the sensed area is larger than a second predefined area threshold; and
disregarding the touch event associated with the first touch object upon determining that the sensed area is larger than the second predefined area threshold;
wherein the first predefined area threshold is smaller than the second predefined area threshold.

6. The graphic editing method according to claim 1, wherein the touch event of step b) is the change in capacitance generated between a plurality of sensing points on the touch panel and the first touch object or a second touch object.

7. The graphic editing method according to claim 6, wherein the sensed area is the number of the plurality of sensing points on the touch panel having the change in capacitance responsive to the first touch object or the second touch object being greater than a sensing threshold.

8. The graphic editing method according to claim 7, wherein the second touch object is a stylus or a finger.

9. The graphic editing method according to claim 6, further comprising:
e) detecting a touch trace associated with the first touch object or the second touch object upon determining that the sensed area generated responsive to capacitive coupling between the first touch object or the second touch object and the touch panel is larger than the first predefined area threshold; and
f) clearing a screen shown on a display of the electronic device upon determining that the touch trace associated with the first touch object or the second touch object matches a predefined trace or a predefined gesture.

10. A graphic editing method for an electronic device having a touch panel and operating in a graphic editing mode, the graphic editing method comprising:
detecting whether a sensed area generated responsive to capacitive coupling between a touch object and the touch panel is larger than a first predefined area threshold;
causing the electronic device to execute a first function under the graphic editing mode according to an operation performed on the touch panel by a touch object when determined that the sensed area is smaller than the first predefined area threshold; and
causing the electronic device to execute a second function under the graphic editing mode according to the operation performed on the touch panel by the touch object when determined that the sensed area is larger than the first predefined area threshold.

11. The graphic editing method according to claim 10, wherein when the electronic device executes the first function, the electronic device operatively displays a graphical trace according to the operation performed on the touch panel by the touch object.

12. The graphic editing method according to claim 11, wherein when the electronic device executes the second function, the electronic device operatively clears a screen or a portion of the screen shown on a display of the electronic device according to the operation performed on the touch panel by the touch object.

13. The graphic editing method according to claim 12, wherein while the electronic device executes the first function, the electronic device is automatically driven to switch from executing the first function to executing the second function upon determining that the sensed area is larger than the first predefined area threshold.

14. The graphic editing method according to claim 12, wherein the sensed area is the number of the plurality of sensing points on the touch panel having the change in capacitance responsive to the touch object being greater than a sensing threshold.

15. The graphic editing method according to claim 12, further comprising:
detecting a touch trace associated with the touch object when the sensed area generated responsive to capacitive coupling between the touch object and the touch panel is larger than the first predefined area threshold; and
clearing a screen shown on the display of the electronic device when determined that the touch trace associated with the touch object matches a predefined trace or a predefined gesture.

16. The graphic editing method according to claim 12, further comprising:
correspondingly clearing a portion of the screen shown on the display of the electronic device according to a touch trace of the touch object sensed by touch panel.

17. The graphic editing method according to claim 10, wherein the touch object is a stylus or a finger.

18. An electronic device, comprising:
a display;
a touch panel disposed on one side of the display, the touch panel configured to sense a sensing information associated with a first touch object on the touch panel, the sensing information at least comprising a sensed area between the first touch object and the touch panel; and
a control unit coupled to the display and the touch panel, the control unit operatively determining whether the sensed area is larger than a first predefined area threshold; when the control unit determines that the sensed area is smaller than the first predefined area threshold, the control unit operatively executes a first function according to an operation performed on the touch panel by the first touch object; when the control unit determines that the sensed area is larger than the first predefined area threshold, the control unit operatively executes a second function according to the operation performed on the touch panel by the first touch object.

19. The electronic device according to claim 18, wherein the control unit executes the first function and causes the display to display a graphical trace according to the operation performed on the touch panel by the first touch object.

20. The electronic device according to claim 18, wherein the sensed area is the number of the plurality of sensing points on the touch panel having a change in capacitance responsive to the first touch object or a second touch object being greater than a sensing threshold.

21. The electronic device according to claim 18, wherein the control unit executes the second function and correspondingly clears a screen or clears a portion of screen shown on the display based on the operation performed on the touch panel by the first touch object or a second touch object.

22. The electronic device according to claim 21, wherein when the control unit determines that the sensed area is larger than the first predefined area threshold, the control unit correspondingly clears a portion of the screen displayed by the display according to a touch trace of the first touch object or the second touch object sensed by touch panel.

23. The electronic device according to claim 21, wherein when the control unit determines that the sensed area is larger than the first predefined area threshold, the control unit further determines whether a touch trace of the first touch object or the second touch object matches a predefined trace or a predefined gesture; wherein when the control unit determines that the touch trace of the first touch object or the second touch object matches the predefined trace or the predefined gesture, the control unit clears the screen shown on the display.
